(19) United States
(12) Patent Application Publication
(10) Pub. No.: US 2005/0209980 A1
(43) Pub. Date: Sep. 22, 2005

(54) Delivery system and delivery method

(75) Inventors: Tsutomu Ishii, Kanagawa (JP); Tsunemasa Mita, Kanagawa (JP); Ikutaroh Nagatsuka, Tokyo (JP); Minoru Koshimizu, Kanagawa (JP); Yasunori Saito, Kanagawa (JP); Yoshitsugu Hirose, Kanagawa (JP); Hiroyuki Hotta, Kanagawa (JP); Eriko Tamaru, Kanagawa (JP); Kimitake Hasuike, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/978,535

(22) Filed: Nov. 2, 2004

(30) Foreign Application Priority Data
Mar. 18, 2004 (JP) 2004-077666

(51) Int. Cl. G06F 17/60

(52) U.S. Cl. 705/406; 705/8

(57) ABSTRACT

A delivery system that delivers a tangible delivery article includes a mail-receiving apparatus to receive the tangible delivery article which has been delivered. Preferably, a data storage device to retain electronic data is attached to the tangible delivery article, the data storage device includes a first radio section to transceive electronic data by means of radio transmission, and a memory to retain electronic data, and the mail-receiving apparatus includes a receipt detection unit to detect loading of the tangible delivery article into the mail-receiving apparatus, and a second radio section to transmit electronic data on loading time by means of radio transmission so that the data storage device receives the electronic data.

### BACKGROUND OF THE INVENTION

1. Field of the Invention

The present invention relates to a technique for delivery management of tangible articles, such as documents printed on paper medium, by means of a data storage device having a function of transceiving electronic data and a memory function of retaining electronic data.

2. Description of the Related Art

In recent years, an increasing number of documents, such as business correspondence and letters, have been sent as mails in electronic data format. However, in the case where the number of pages is large, a required degree of secrecy is high, or the like, a document is sent in a form of printed papers (hereinafter referred to as “tangible document”) from a sender to a recipient.

A service that delivers such a tangible document or tangible article, such as a package, has utilized a thin, compact tag or card having a radio communication function.

For instance, there is proposed a container box delivery system which utilizes an RFID card—for visually displaying information of a product name, a product number, and a handling method—and which delivers the container box with the RFID card attached to a container box of a product, wherein information to be displayed on a display panel is transmitted to the RFID card by means of radio transmission, thereby enabling rewrite of the information to be displayed on the display panel in a non-contact manner and negating the need to replace the RFID card (see JP-A-2001-155129).

Furthermore, such a tag has been utilized for stock management. For instance, for a case where a large quantity of articles is under storage management in a warehouse, or the like, there is proposed a stock management system wherein a tag having a radio transmission function is attached to each article, and article locations are managed on the basis of intensity of transmission signals received from the respective tags (see JP-A-2000-357251).

### SUMMARY OF THE INVENTION

As described above, a variety of inventions have been proposed in relation to delivery of tangible documents or articles. However, a system which satisfactorily utilizes attached hardware, a so-called tag, card, or the like, having a radio communication function has not yet been proposed.

Known attached hardware attached to such tangible delivery articles include that having, in addition to a radio communication function, a memory function for retaining electronic data, or a display function for displaying information. However, a system which rationally utilizes such functions from the viewpoint of delivery service has not yet been proposed.

The present invention has been conceived in view of the above circumstances and aims to realize rational delivery management of tangible delivery articles through use of at least a data storage device in the form of a tag or card having a function for transceiving electronic data and a memory function for retaining electronic data.

Furthermore, the invention aims at providing unified receipt management of the tangible delivery articles on the recipient side in conjunction with receipt of e-mails, or the like, on a user information terminal such as a personal computer.

According to the invention, a tangible delivery article is delivered while having attached thereto a data storage device having a radio section for transmitting/receiving electronic data by means of radio transmission, and a memory for retaining electronic data. A mail-receiving apparatus, to which the article is to be delivered, detects loading of the tangible deliver article thereinto by use of a receipt detection unit. A radio section in the mail-receiving apparatus transmits electronic data on the loaded time so that the data are received by the data storage device in the tangible delivery article. For instance, the tangible delivery article is a tangible document, and the data storage device is a thin, compact RF tag. The data storage device is affixed on the surface of an envelope containing the tangible document.

Accordingly, information associated with delivery regarding when the tangible delivery article has been delivered is transmitted to the data storage device and stored in the memory. The information data can be utilized for receipt management of the tangible delivery article.

In the invention, in relation to a mail-collecting apparatus for collecting a tangible delivery article to be delivered, when a mailing detection unit detects loading of a tangible delivery article into the mail-collecting apparatus, a radio section transmits electronic data on a loading time by means of radio transmission so that the data storage device in the tangible delivery article can receive the data.

Therefore, information associated with delivery regarding the time when the tangible delivery article has been loaded is transmitted to the data storage device and stored in the memory. Therefore, the information data can be utilized in receipt management of the tangible delivery article.

According to the invention, information data associated with delivery of a tangible delivery article can be stored in a data storage device merely by loading the tangible article having the data storage device attached thereto into a mail-collecting apparatus or a mail-receiving apparatus. Accordingly, for instance, data log associated with sending or delivery can be recorded automatically, thereby implementing rational delivery management of tangible delivery articles by applying the data log to computerized information management.

Furthermore, according to the invention, receipt of a tangible delivery article is notified to a user by means of an e-mail message. Therefore, unified receipt management of tangible delivery articles on the recipient side in conjunction with that of e-mails, or the like, is enabled.

### BRIEF DESCRIPTION OF THE DRAWINGS

Preferred embodiment of the present invention will be described in detail based on the following figures, wherein:

FIG. 1 is a diagram showing an intra-company delivery system according to an embodiment of the present invention;

FIGS. 2A and 2B are diagrams showing a photo-write-type RF tag according to an embodiment of the invention;

FIG. 3 is a diagram showing a self-rewrite-type RF tag according to an embodiment of the invention;

FIG. 4 is a diagram explaining data retained in a memory of the RF tag according to an embodiment of the invention;

FIG. 5 is a diagram showing a screen display of an incoming mail list according to an embodiment of the invention;

FIGS. 6A and 6B are diagrams showing photo-write-type electronic paper;

FIG. 7 is a diagram explaining how the photo-write-type electronic paper is used;

FIG. 8 is a diagram explaining operating principles of the photo-write-type electronic paper;

FIG. 9 is a diagram explaining a structure of the photo-write-type electronic paper;

FIGS. 10A and 10B are diagrams showing self-rewrite-type electronic paper;

FIG. 11 is a diagram explaining operating principles of the self-rewrite-type electronic paper; and

FIG. 12 is a diagram explaining a structure of the self-rewrite-type electronic paper.

### DETAILED DESCRIPTION OF THE INVENTION

The present invention will be specifically described by reference to an embodiment.

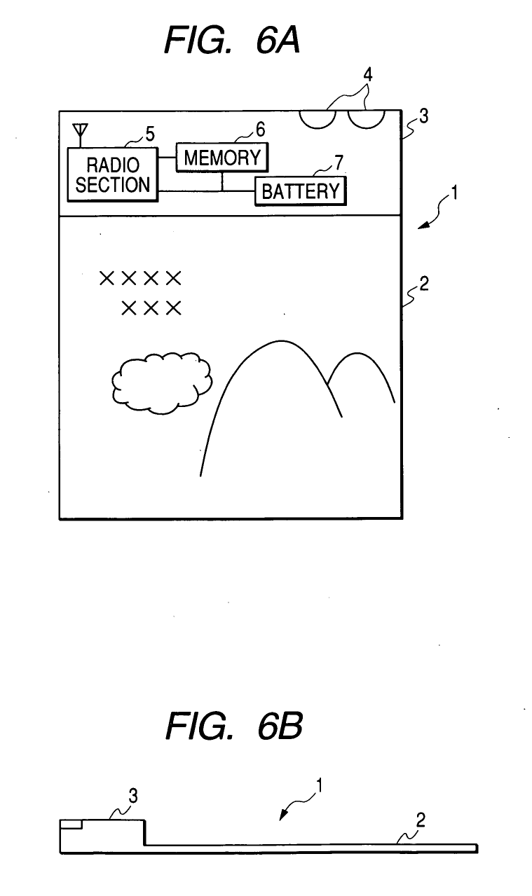

First, an example of a data storage device for use with the invention will be described by reference to FIGS. 6A to 12.

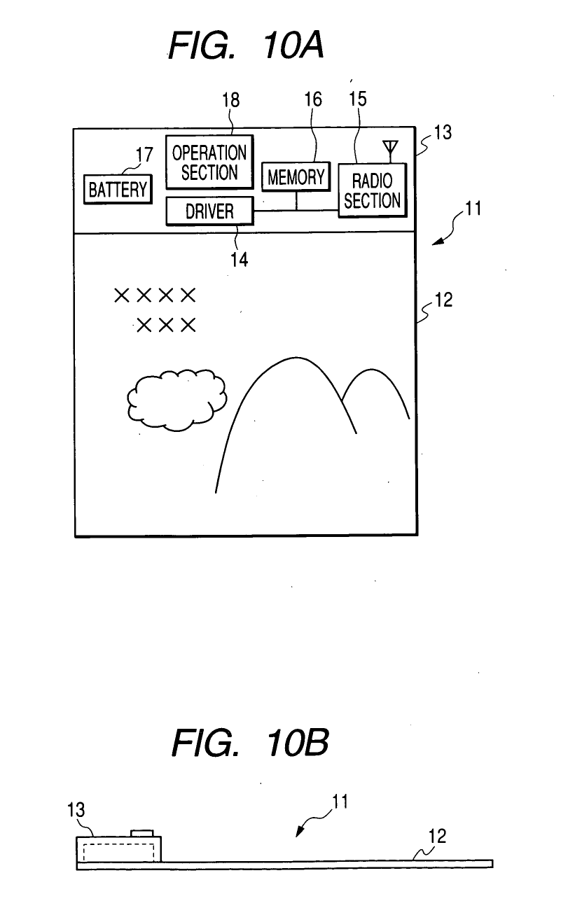

Data storage devices can be broadly categorized, in terms of the recording method of display information, into a photo-write type shown in FIGS. 6A to 9 and a self-rewrite type shown in FIGS. 10 to 12. Both types are paper-like thin devices, so-called “electronic paper.”

FIG. 6A shows a front view of a photo-write-type data storage device 1. FIG. 6B shows a side view of the photo-write-type data storage device 1. The data storage device 1 shown in the drawings has a display section 2 for displaying and retaining information images, and a processing section 3 for processing electronic data. FIG. 6A also shows built-in functional sections in the processing section 3.

The photo-write-type data storage device 1 is of a size of, e.g., A-4 size paper, and is flexible and of low profile. The processing section 3 is disposed at one portion of the display section 2 which occupies most of the surface area of the data storage device 1. The display section 2 is of arbitrary size, and is assumed to be of a size suitable for the purpose when used as a tag or card, as will be described later.

The processing section 3 has electrodes 4 for applying voltage to drive the display section 2, as will be described later, a radio section 5 for effecting radio communication with the outside, a memory 6 for retaining electronic data in a readable/writable manner, and a battery 7 for supplying driving power to the radio section 5 and the memory 6.

The photo-write-type data storage device 1 is capable of transceiving electronic data by means of radio transmission between the radio section 5 and the outside radio communication device (unillustrated), and retaining the electronic data in the memory 6.

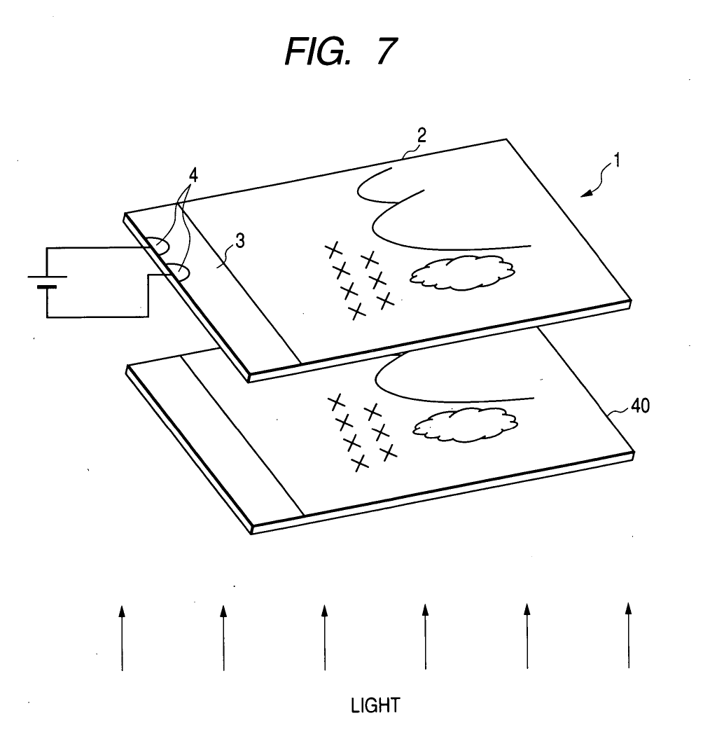

For instance, as shown in FIG. 7, the photo-write-type data storage device 1 displays information, as an image, on a liquid crystal panel 40. Further, light is emitted on the photo-write-type data storage device 1 superposed on the liquid crystal panel 40 while voltage is applied on the electrodes 4 from the outside power source. Accordingly, the display information displayed on the liquid crystal panel 40 can be transferred on the display section 2, and stored.

A contents image of a document can also be transferred and stored by means of emitting light on a sheet of document paper, such as a printed material, which is superposed on the photo-write-type data storage device 1 while voltage is applied on the electrodes 4. That is, the photo-write-type data storage device 1 is capable of transferring the projected image information to the display section 2 by means of applying voltage on the electrodes 4, and retaining the image information under the displayed state even after the voltage applied on the electrodes 4 is removed.

In terms of a cross-sectional structure of the display section 2 shown in FIG. 9, the photo-write-type data storage device 1 is configured as follows, a photoconductor layer of organic material (hereinafter referred to as “organic photoconductor layer”) 20—which are utilized in a copier—and a layer of liquid crystal display material (microencapsulated cholesteric liquid crystal layer) 21 are combined and sandwiched between a pair of transparent electrodes 22, and the laminated member is sandwiched between a pair of transparent substrate films 23. The above configuration enables a monochrome image display on the basis of white display where the cholesteric liquid crystal layer 21 reflects light and black display where light transmitted through the liquid crystal layer 21 is absorbed in a black layer 24 interposed between the cholesteric liquid crystal layer 21 and the organic photoconductor layer 20. Furthermore, by utilizing the characteristic of a cholesteric liquid crystal that it interferes and reflects color lights in accordance with a helical pitch, a multi-color display can also be realized with a simple structure where the cholesteric liquid crystal layer 21 is configured by laminating liquid crystals having different helical pitches.

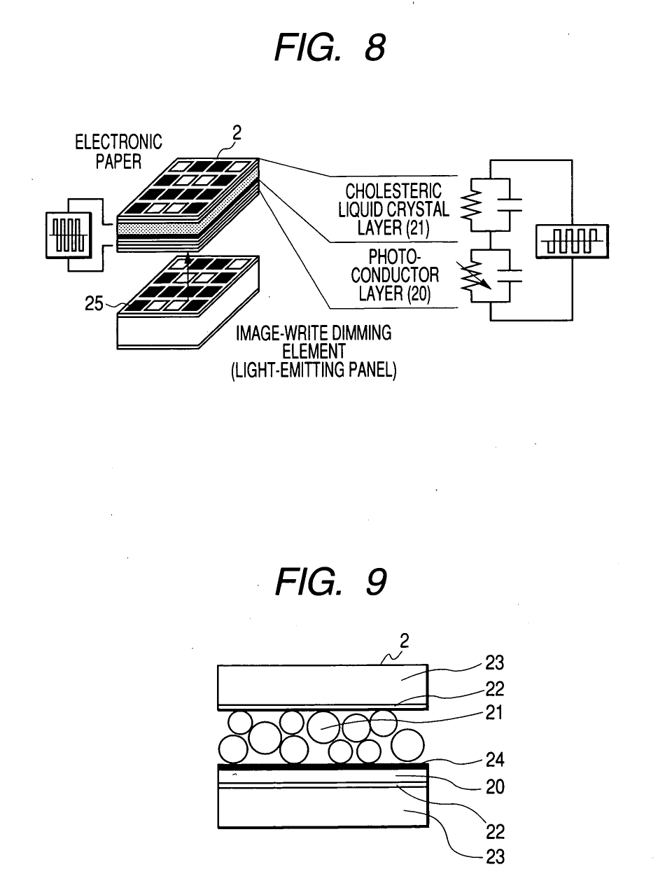

As shown in FIG. 8, which illustrates the operating principles of the display section 2, the photo-write-type data storage device 1 projects an image to be transferred on, e.g., an image-write dimming element panel (a light-emitting panel) 25, when voltage is applied on the electrodes 4, the photo-write-type data storage device 1 instantaneously converts differences in light intensity into reflection density, thereby retaining the thus-projected image. The image information retained in the display section 2 can be erased by application of erasing voltage on the electrodes 4. That is, the photo-write-type data storage device 1 permits repeated reuse by repeating writing and erasing. The photo-write-type data storage device 1 can also project anew image by application of voltage on the electrodes 4 as described above, to thus overwrite the image information retained in the display section 2 without conducting the above-mentioned erasing operations. That is, the photo-write-type data storage device 1 can also be repeatedly reused by means of such an overwrite operation.

As described above, the photo-write-type data storage device 1 has a characteristic of retaining image information transferred by means of image projection without power supply, in addition to being paper-thin and flexible. Therefore, the photo-write-type data storage device 1 is a recording medium which can be used as if it were paper for use with a printer or a copier, and which, moreover, permits repeated reuse.

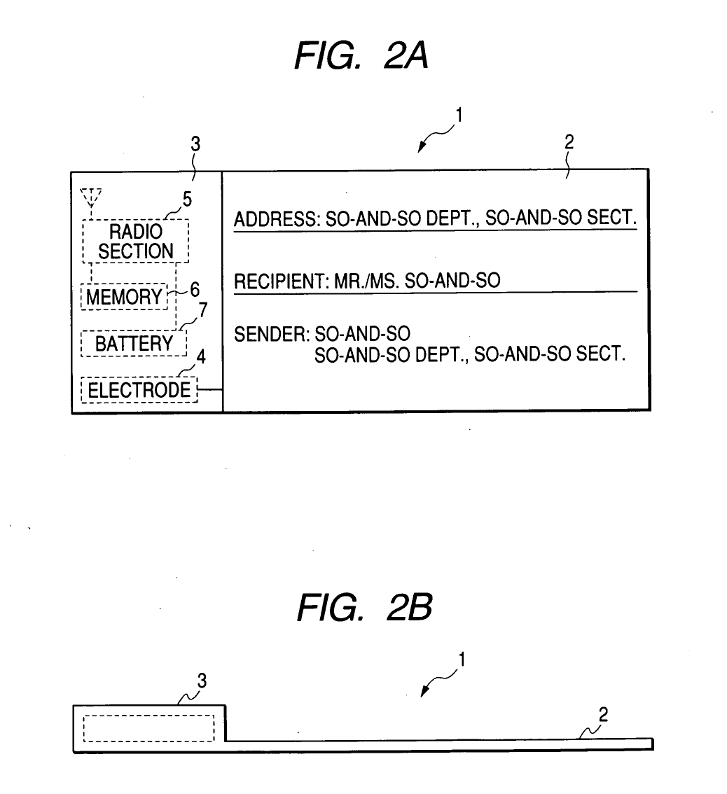

Furthermore, the photo-write-type data storage device 1 of the example has a radio communication function and a memory function. Therefore, as will be described later with reference to FIGS. 2A and 2B, it can be used as an RF tag, or the like, which can be rewritten in a non-contact manner and which has a display function, accordingly, it can be used as a device having both a function of retaining visible image information in a displayed state and a function of retaining electronic data.

FIG. 10A shows a front view of a self-rewrite-type data storage device 11. FIG. 10B shows a side view of the self-rewrite type data storage device 11. The data storage device 11 shown in the drawings has a display section 12 for displaying and retaining information image, and a processing section 13 for processing electronic data. FIG. 10A also shows other built-in functional sections of the processing section 13.

The self-rewrite-type data storage device 11 is, as in the case of the photo-write-type data storage device 1, a low-profile, flexible display device of a size of, e.g., A-4 size paper. The processing section 13 is disposed on one portion of the display section 12 which occupies most of the surface area of the data storage device 11. As is the case with the photo-write-type data storage device 1, the display section 12 is assumed to be of a suitable size for the purpose.

The processing section 13 has a driver 14 for driving the display section 12, as will be described later, a radio section 15 for effecting radio communication with the outside, a memory 16 for retaining electronic data in a readable/writable manner, a battery 17 for supplying driving power to the driver 14, the radio section 15, and the memory 16, and an operation section 18, such as a button, for receiving operation input with regard to image information displayed by the driver 14.

The self-rewrite-type data storage device 11 is capable of transceiving electronic data by means of radio transmission between the radio section 15 and the outside radio communication device (unillustrated), and retaining the electronic data in the memory 16.

Furthermore, in contrast with the photo-write-type data storage device 1, the self-rewrite-type data storage device 11 has the following functions, the driver 14 displays image information on the display section 12 on the basis of electronic data retained in the memory 16, image information to be displayed is switched/changed in accordance with operation input from the operation section 18, and display of image information on the display section 12 is retained even after driving power from the driver 14 is removed.

In terms of a cross-sectional structure of the display section 12 shown in FIG. 12, the self-rewrite-type data storage device 11 is configured as follows, fine coloring particles (in the example shown in the drawing, white particles 31 and black particles 32) utilized as toner for a copier are sealed between a pair of electrodes 33, of which at least a surface side is transparent, and the laminated member is sandwiched between a pair of film substrates 34, of which at least a surface side is transparent. The space between the electrode layers 33 is an air layer, thereby allowing free motion of the coloring particles 31, 32. Furthermore, an insulation layer 35 for inhibiting contact with the coloring particles 31, 32 is disposed on the electrode layers 33 of a matrix form. A multi-color display can also be realized with a simple structure by means of adapting a color filter.

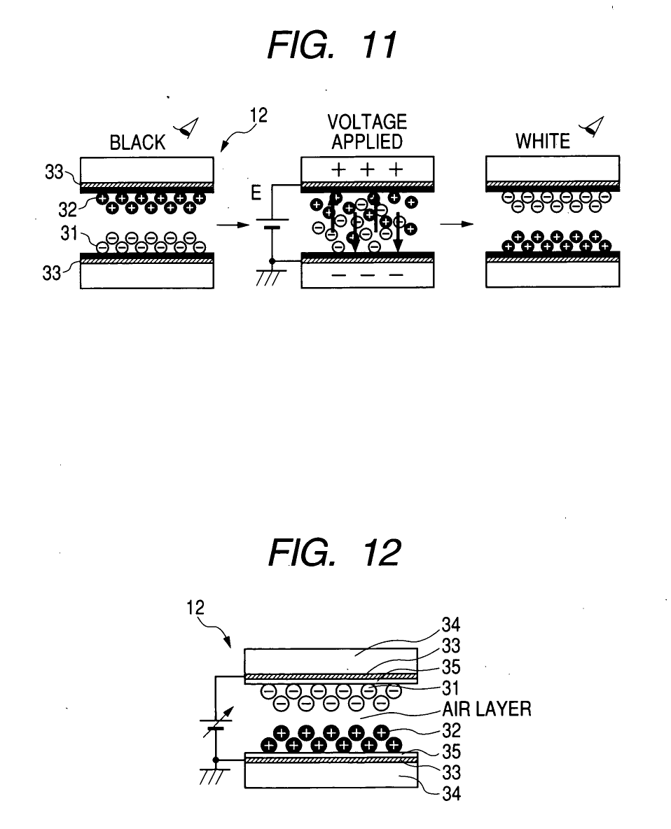

In the self-rewrite-type data storage device 11, as shown in FIG. 11, which illustrates operating principles of the display section 12, under a state where no voltage is applied on the electrode 33 (note that the electrodes 33 are charged in the same polarity as used in the previous driving), the negatively charged white particles 31 remain on the back side, and the positively charged black particles 32 remain on the surface side. Accordingly, the display section 12 is black when viewed from the surface side. When the driver 14 is driven in accordance with the electronic data and reverses electrode polarities of desired portions on the matrix in accordance with image information to be displayed, contrast is reversed with regard to the white particles 31 and the black particles 32, whereby image information is displayed on the display section 12 by means of contrast between the white particles 31 and the black particles 32. By driving the driver 14 in accordance with different electronic data, image information displayed on the display section 12 by means of contrast on the white particles 31 and the black particles 32 can be switched, thereby enabling repeated reuse.

As described above, the self-rewrite-type data storage device 11 has a characteristic of retaining image information displayed on the display section 12 without power supply, in addition to being paper-thin and flexible. That is, the self-rewrite-type data storage device 11 is a recording medium which can be used as if it were paper.

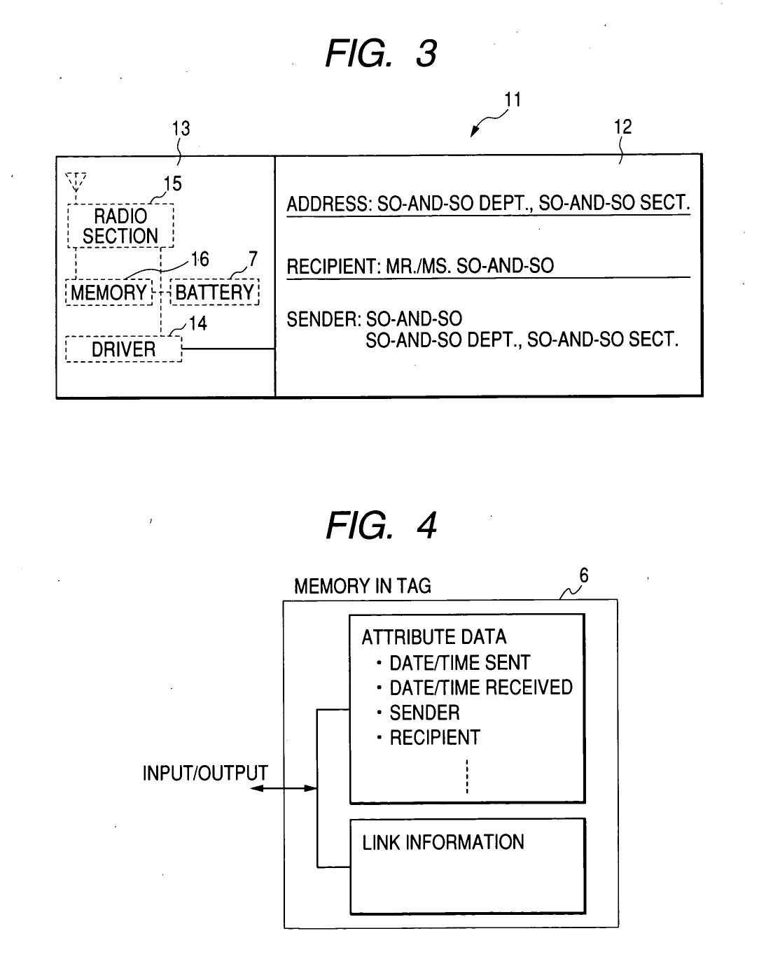

Furthermore, the self-rewrite-type data storage device 11 of the example has a radio communication function and a memory function. Therefore, as will be described later with reference to FIG. 3, it can be used as an RF tag, or the like, whose electronic data can be rewritten in a non-contact manner and which has a display function. Accordingly, the self-rewrite-type data storage device 11 can be used as a device having both a function of retaining visible image information in a displayed state and a function of retaining electronic data.

FIGS. 2A and 2B show a photo-write-type RF tag 1 used as a data storage device in an embodiment of a delivery system, which will be described later. FIG. 2A is a front view, and FIG. 2B is a side view. The photo-write-type RF tag 1 adapted in the embodiment is of a relatively small size for use in being affixed on a tangible document or an envelope as an address tag. The other basic configurations and functions are identical with those of the photo-write-type data storage device 1 shown in FIGS. 6A to 9. Accordingly, identical configurations and functions are denoted by the same reference numerals, and repeated descriptions are omitted.

The photo-write-type RF tag 1 has the display section 2 and the processing section 3 for processing electronic data. Further, as shown in FIG. 2A, the photo-write-type RF tag 1 further includes, as built-in functional sections in the processing section 3, the electrode 4 for applying voltage to drive the display section 2, the radio section 5 for effecting radio communication with the outside, the memory 6 for retaining electronic data in a readable/writable manner, and the battery 7 for supplying driving power to the radio section 5 and the memory 6.

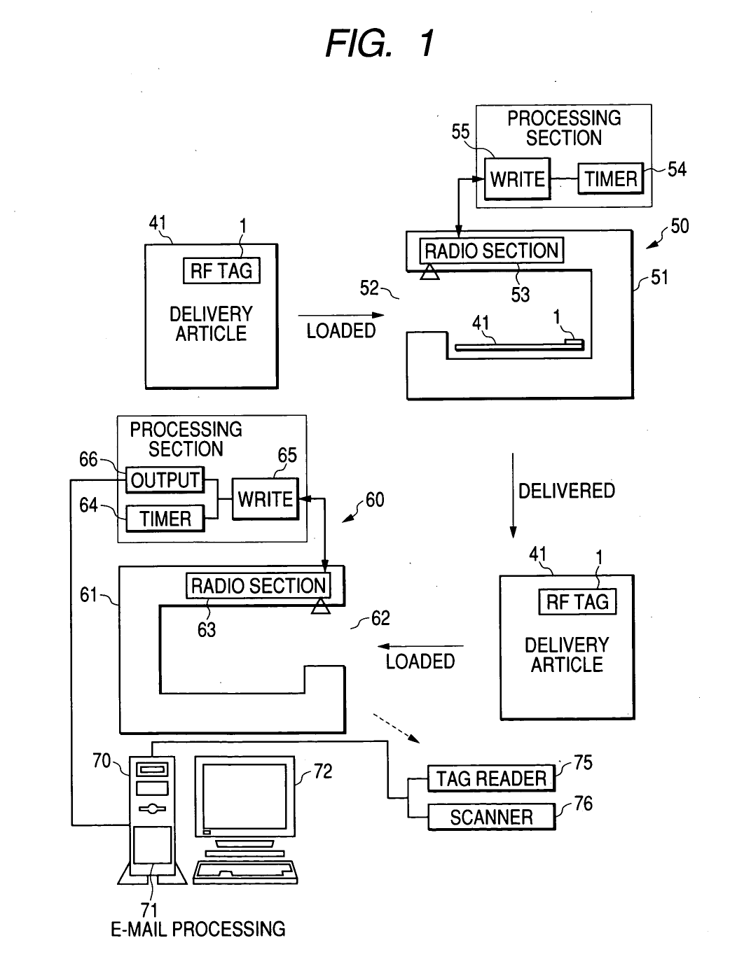

For a case where a tangible delivery article, such as a tangible document, is delivered, the photo-write-type RF tag 1 is utilized also as a display tag of delivery information by being affixed on the surface of a tangible delivery article 41 as shown in FIG. 1, which shows an intra-company delivery system of the embodiment. For instance, as shown in FIGS. 2A and 2B, delivery information including an address (So-and-so Dept., So-and-so Sect.), a recipient (Mr./Ms. So-and-so), and a sender (So-and-so, So-and-so Dept., So-and-so Sect.) is written in the display section 2 by means of the above-mentioned photo write technique.

As an alternative method to the above-mentioned writing in the display section 2, the delivery information may be transmitted as electronic data by means of radio transmission, received by the radio section 5, and retained in the memory 6, thereafter the electronic data may be read from the memory 6 for the use of computerized delivery management of tangible delivery articles.

Hereinafter, an example of the intra-company delivery system shown in FIG. 1 which utilizes the photo-write-type RF tag 1 will be described. However, a self-rewrite type RF tag 11 such that shown in FIG. 3 may alternatively be used as a data storage device 11 to be attached to a tangible delivery article.

The self-rewrite-type RF tag 11 shown in FIG. 3 is identical with the photo-write-type RF tag 1 in terms of having a relatively small size so as to allow the RF tag to be affixed on a tangible document or an envelope as an address tag. The other basic configurations and functions are identical with those of the self-rewrite-type data storage device 11 shown in FIGS. 10A to 12. Accordingly, identical configurations and functions are denoted by the same reference numerals, and repeated descriptions are omitted.

In addition, in the invention, the main purpose of the data storage device attached to a tangible delivery article is to receive information data associated with delivery information, such as date and time sent and date and time received, in a non-contact manner, and to store the same in the memory. Therefore, the delivery information may be written on the tangible delivery article in pen or pencil while the display function of the display section 2, 12 is omitted from the RF tag 1, 11 having a radio communication function and a memory function.

A configuration similar to the above may be adopted, for either the photo-write type or the self-write type, such that functional sections for radio communication and memory, such as the radio section, the memory, and the battery, are configured as another RF IC tag separated from the display section, and the RFIC tag is attached to the data storage device. Furthermore, in the case where the RF IC tag is adapted, the battery may be a capacitor which holds electromotive force from the tag reader.

As is apparent, a data storage device of a type other than the self-write type and the photo-write type may be applied in the invention. For instance, there may be used a data storage device which is loaded on an external rewrite device and which, like the self-write type, electronically writes contents image in the display section. In other words, the above-mentioned self-write type is an example of a data storage device of a type which does not require an external image write device, and the photo-write type is an example of a data storage device of a type which requires an external image write device.

For the display section 2 (12), there may be used liquid crystal having memory property, such as ferroelectric liquid crystal, an electrophoretic method for switching display by means of moving charged particles, a particle rotation method for switching display by means of rotating charged particles, a magnetic migration method for switching display by means of magnetically moving particles, a thin liquid crystal driven by means of a small battery, or an electroluminescence (EL) element.

Next, the intra-company delivery system making use of the RF tag 1 will be described by reference to FIG. 1.

The intra-company delivery system of the example has a mail-collecting apparatus 50 in which a sender user throws-in the tangible delivery article 41 so as to deliver the same, and a mail-receiving apparatus 60 in which the tangible delivery article having been delivered for receipt by a recipient user is loaded. For instance, the mail-collecting apparatus 50 and the mail-receiving apparatus 60 are provided as a personal mailbox within the company. The mail-collecting apparatus 50 and the mail-receiving apparatus 60 for each person may be configured integrally.

In the intra-company delivery system of the example, in advance of sending of the delivery article, delivery information, such as an address, is written and displayed on the display section 2 on the RF tag 1, which is a data storage device. Furthermore, attribute information, such as a sender and the address, is stored in the memory 6. The tangible delivery article 41, on which the RF tag 1 is affixed, is loaded into the mail-collecting apparatus 50. As a result, a delivery service person delivers the tangible delivery article on the basis of the delivery information displayed on the RF tag 1, and throws-in the tangible delivery article 41 into the mail-receiving apparatus 60 of the recipient user.

In the example, link information data of the electronic data on the document has been stored in the memory 6 in advance of the sending so that the electronic data on the document contents of the tangible delivery article 41 can be obtained. As a result, the recipient user who received the tangible document 41 can obtain the electronic data of the tangible document by means of reading the link information data from the memory 6 with a computer 70 and accessing the network.

In the memory 6, for instance, as shown in FIG. 4, link information data is stored in addition to attribute information, such as the sender user (sender) and the recipient user (recipient), which has been input as described above. Furthermore, tangible data on the tangible document may be stored in the memory 6. Information data associated with delivery, such as date and time sent or date and time received, is written in the memory 6 in a non-contact manner when the tangible delivery article 41 to which the RF tag 1 is attached is loaded into the mail-collecting apparatus 50 and the mail-receiving apparatus 60.

The mail-collecting apparatus 50 has a box-shaped main body 51 including an inlet 52 for loading the tangible delivery article 41, a radio section 53 for detecting passage of the RF tag 1 through the inlet 52 and effecting radio communication with the RF tag 1, and a write processing section 55. The write processing section 55 causes the radio section 53 to transmit date and time information clocked by a timer 54 in response to passage of the RF tag 1 through the inlet 52, by means of radio transmission.

Therefore, when the tangible delivery article 41 to which the RF tag 1 is attached is loaded into the mail-collecting apparatus 50, data on loading date and time transmitted from the radio section 53 are received in the radio section 5 of the RF tag 1, and stored in the memory 6. That is, the tangible delivery article 41 is delivered with real-time date and time sent data automatically added thereto. Attribute information data, such as sender or recipient, may be written in the memory 6 by means of the radio communication during the above-mentioned load timing.

The mail-receiving apparatus 60 has a box-shaped main body 61 including an inlet 62 for loading the tangible delivery article 41, a radio section 63 for detecting passage of the RF tag 1 through the inlet 62 and effecting radio communication with the RF tag 1, and a write processing section 65. The write processing section 55 causes the radio section 63 to transmit date and time information clocked by a timer 64 in response to passage of the RF tag 1 through the inlet 62, by means of radio transmission.

Therefore, when the tangible delivery article 41 to which the RF tag 1 is attached is loaded into the mail-receiving apparatus 60, data on loading date and time transmitted from the radio section 63 are received in the radio section 5 of the RF tag 1, and stored in the memory 6. That is, the tangible delivery article 41 is delivered with real-time receipt date and time data automatically added thereto.

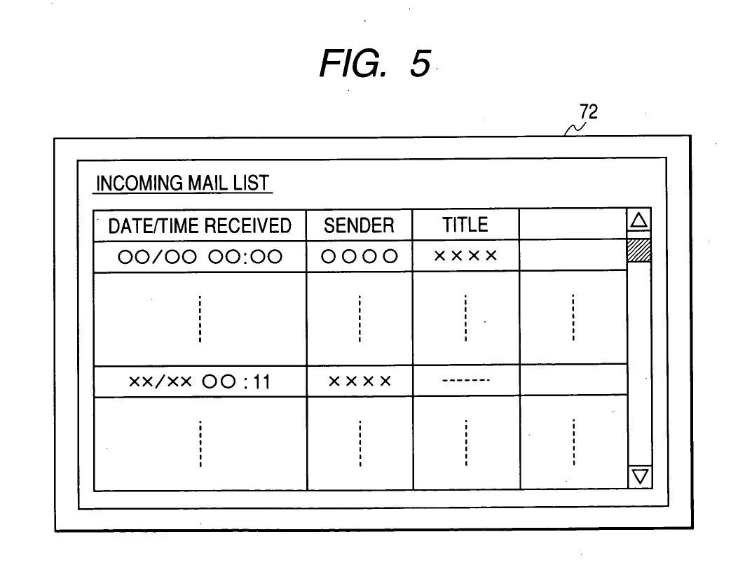

The computer 70 used by the recipient user includes a e-mail processing function 71 for processing receipt of e-mails, and, as shown in FIG. 5, is capable of displaying e-mails received via the network in the form of an incoming mail list on a display screen 72.

The mail-receiving apparatus 60 has a notification output section 66 for sending e-mails. Upon detection of passage of the RF tag 1 through the radio section inlet 62 by the radio section 63, the notification output section 66 sends a receipt notification e-mail to a mail address of the recipient user which has been set as an administrator of the mail-receiving apparatus 60 in advance.

Accordingly, every time the delivered tangible delivery article 41 is loaded into the mail-receiving apparatus 60, an e-mail which notifies receipt of the tangible delivery article 41 is sent to the computer 70 used by the recipient user. As a result, a list of receipt notification e-mails regarding the delivered articles and incoming e-mails for normal communication are listed on the display screen 72 of the computer 70. Accordingly, the user is capable of managing receipt of e-mails and that of tangible delivery articles in a unified manner. Furthermore, the user can check receipt of tangible delivery articles on the display screen without checking the actual mail-receiving apparatus 60.

The receipt notification e-mails of the tangible delivery articles and normal communication e-mails are not necessarily listed as described above, and may be displayed separately. Each of the receipt notification e-mails of the tangible delivery articles preferably contains receipt date and time, which is loading date and time clocked by a timer, and attribute information obtained from the memory 6 by means of radio communication between the radio sections 63 and 5, however, even a so-called blank mail, which does not contain such information, functions as a receipt notification.

A non-contact-type tag reader 75 and a scanner 76 for image scanning are disposed in the computer 70 used by the recipient user. Accordingly, upon receipt of the tangible document 41, the user can capture contents of the tangible document as display information in the computer 70 by means of the scanner 76, and import electronic data stored in the memory 6 to the computer 70 by way of the RF tag 1 attached to the tangible document 41.

Consequently, image data on the received tangible document and electronic data, such as attribute information, can be utilized by the computer 70, that is, the computer can be used to effect not only sending/receiving of tangible documents, but also various types of information processing in relation to receipt of the tangible document.

In the invention, upon detection of loading of the tangible delivery article into the mail-receiving apparatus, a receipt notification e-mail is sent to an address which has been set in advance.

Accordingly, when, for instance, a personal computer or a mobile tool of a user has been set as a recipient address, receipt of tangible delivery articles can be managed in a unified manner in conjunction with e-mails sent/received between users for the purpose of communication.

Furthermore, in the invention, the data storage device includes a display section for displaying information which specifies at least an address in a rewritable manner. Therefore, information for delivery of a tangible article can be visually checked. Accordingly, the data storage device can also be used as an address display such as an address label, or the like.

Moreover, in the invention, in the case where the tangible delivery article is a tangible document, link information for access to electronic data on contents of the document is retained in the memory of the data storage device attached to the delivery article. Accordingly, a user who receives the tangible article can obtain electronic data of the document by means of accessing electronic data on the document contents retained on the network by use of the link information, in addition to the document recorded on the tangible medium. That is, the user can utilize the contents for editing of the document contents or for a secondary application.

The entire disclosure of Japanese Patent Application No. 2004-077666, filed on Mar. 18, 2004 including specification, claims, drawings and abstract is incorporated herein by reference in its entirety.

1. A delivery system that delivers a tangible delivery article comprising:
a mail-receiving apparatus to receive the tangible delivery article which has been delivered, wherein
a data storage device to retain electronic data is attached to the tangible delivery article,
the data storage device includes:
a first radio section to transceive electronic data by means of radio transmission; and
a memory to retain electronic data, and
the mail-receiving apparatus includes:
a receipt detection unit to detect loading of the tangible delivery article into the mail-receiving apparatus; and
a second radio section to transmit electronic data on loading time by means of radio transmission so that the data storage device receives the electronic data.

2. The delivery system according to claim 1, wherein
the mail-receiving apparatus further comprises:
a notification output unit to send, to an address which has been set in advance, an e-mail notifying receipt of the delivery article, upon detection of loading of the tangible delivery article into the mail-receiving apparatus.

3. A delivery system that delivers a tangible delivery article comprising:
a mail-collecting apparatus to collect the tangible delivery article to be delivered, wherein
a data storage device to retain electronic data is attached to the tangible delivery article,
the data storage device includes:
a first radio section to transceive electronic data by means of radio transmission; and
a memory to retain electronic data, and
the mail-collecting apparatus includes:
a mailing detection unit to detect loading of the tangible delivery article into the mail-collecting apparatus; and
a second radio section to transmit electronic data on loading time by means of radio transmission so that the data storage device receives the electronic data.

4. A delivery system that delivers a tangible delivery article comprising:
at least one of a mail-collecting apparatus to collect the tangible delivery article to be delivered and a mail-receiving apparatus to receive the tangible delivery article which has been delivered, wherein
a data storage device to retain electronic data is attached to the tangible delivery article,
the data storage device includes:
a first radio section to transceive electronic data by means of radio transmission; and
a memory to retain electronic data, and
each of the mail-collecting apparatus and the mail-receiving apparatus includes:
a receipt detection unit to detect loading of the tangible delivery article; and
a second radio section to transmit electronic data on delivery of the tangible delivery article by means of radio transmission so that the data storage device receives the electronic data.

5. The delivery system according to claim 1, wherein
the data storage device comprises:
a display section to display information which specifies at least an address in a rewritable manner.

6. The delivery system according to claim 2, wherein
the data storage device comprises:
a display section to display information which specifies at least an address in a rewritable manner.

7. The delivery system according to claim 3, wherein
the data storage device comprises:
a display section to display information which specifies at least an address in a rewritable manner.

8. The delivery system according to claim 4, wherein
the data storage device comprises:
a display section to display information which specifies at least an address in a rewritable manner.

9. The delivery system according to claim 1, wherein
the tangible delivery article is a document, and
the memory of the data storage device which is to be attached to the delivery article retains link information for access to electronic data on contents of the document.

10. The delivery system according to claim 2, wherein
the tangible delivery article is a document, and
the memory of the data storage device which is to be attached to the delivery article retains link information for access to electronic data on contents of the document.

11. The delivery system according to claim 3, wherein
the tangible delivery article is a document, and
the memory of the data storage device which is to be attached to the delivery article retains link information for access to electronic data on contents of the document.

12. The delivery system according to claim 4, wherein
the tangible delivery article is a document, and
the memory of the data storage device which is to be attached to the delivery article retains link information for access to electronic data on contents of the document.

13. The delivery system according to claim 5, wherein
the tangible delivery article is a document, and
the memory of the data storage device which is to be attached to the delivery article retains link information for access to electronic data on contents of the document.

14. The delivery system according to claim 6, wherein
the tangible delivery article is a document, and
the memory of the data storage device which is to be attached to the delivery article retains link information for access to electronic data on contents of the document.

15. The delivery system according to claim 7, wherein
the tangible delivery article is a document, and
the memory of the data storage device which is to be attached to the delivery article retains link information for access to electronic data on contents of the document.

16. The delivery system according to claim 8, wherein
the tangible delivery article is a document, and
the memory of the data storage device which is to be attached to the delivery article retains link information for access to electronic data on contents of the document.

17. A delivery method comprising:
delivering a tangible delivery article to which a data storage device is attached,
causing a mail-receiving apparatus to transmit electronic data on loading time by means of radio transmission when the tangible delivery article which has been delivered is loaded into the mail-receiving apparatus,
causing the data storage device attached to the tangible delivery article to receive the electronic data on loading time which has been transmitted, and
causing a memory disposed in the data storage device to retain the electronic data on loading time.

18. The delivery method according to claim 17, wherein
upon detection of loading of the tangible delivery article into the mail-receiving apparatus, the mail-receiving apparatus sends, to an address which has been set in advance, an e-mail notifying receipt of the tangible delivery article.

19. A delivery method comprising:
when a tangible delivery article to which a data storage device is attached is loaded into a mail-collecting apparatus to be delivered,
causing the mail-collecting apparatus to transmit first electronic data on loading time by means of radio transmission;
causing the data storage device attached to the tangible delivery article to receive the first electronic data on loading time which has been transmitted; and
causing a memory disposed in the data storage device to retain the first electronic data on loading time, and
when the tangible delivery article is loaded into a mail-receiving apparatus,
causing the mail-receiving apparatus to transmit second electronic data on loading time by means of radio transmission;
causing the data storage device attached to the tangible delivery article to receive the second electronic data on loading time which has been transmitted; and
causing the memory disposed in the data storage device to retain the second electronic data on loading time.
